(19) United States
(12) Patent Application Publication
(10) Pub. No.: US 2005/0191512 A1
(43) Pub. Date: Sep. 1, 2005

(54) Metal door with decorative panel(s) and process for the manufacture thereof

(76) Inventors: Raymond Ouellette, Varennes (CA); Harold Savard, Boucherville (CA)

Correspondence Address: BAKER & HOSTETLER LLP, WASHINGTON SQUARE, SUITE 1100, 1050 CONNECTICUT AVE. N.W., WASHINGTON, DC, 20036-5304, US

(21) Appl. No.: 11/038,525

(22) Filed: Jan. 21, 2005

(30) Foreign Application Priority Data
Jan. 21, 2004 (CA) 2,456,018

(51) Int. Cl. B32B 15/04

(52) U.S. Cl. 428/627

(57) ABSTRACT

Disclosed is a process for the manufacture of a metal door incorporating at least one decorative panel that gives to the door an aesthetic aspect similar to the one of a wood door. In this process, at least one of the metal plates used to form the door are subjected to prior to being mounted onto the corresponding frame, in order to form zones having the requested decorative aspect at a given place thereon. Thus, the two metal plates are assembled onto the frame in order to form a hollow structure. The hollow structure that is so formed is subsequently inserted into a mold and an insulating material is injected therein. Thereafter, the door that is so obtained is cut to separate from the same one or more decorative panels at the places where have been formed the zones of decorative aspect. Such a cutting gives one or more corresponding openings into the door. Last of all, the one or more decorative panels that have previously been cut can be reinstalled into the corresponding openings made into the same door or into opening(s) of another door of the same shape and size. Alternatively, one of the panels may be replaced by a window frame.

### FIELD OF THE INVENTION

The present invention relates to a process for the manufacture of a metal door incorporating one or more decorative panels that give to the door an aesthetic aspect similar to the one of a wood door.

The invention also relates to the metal door that is so manufactured.

### BACKGROUND OF THE INVENTION

It is known to manufacture doors or window door frames made of metal. The method that is commonly used for doing so consists in assembling two metal plates, preferably made of steel, onto a rectangular frame comprising two vertical bars and two cross-bars in order to form a hollow door structure, the metal plates respectively acting as front surface and rear surface of the door. Once the assembly is completed, the hollow structure is located in the mold provided with an injection system in order to fill up the hollow structure with an insulating material, preferably polyurethane. The door that is so obtained can then be used as such or can be subjected to a cutting in view of forming one or more opening in which are installed, by means of plastic moldings, window frames or filling panels each provided with two opposite surfaces preferably made of hot galvanized steel and extruded aluminium, which are previously formed and/or molded so as to give to the metal door, once installed, give to the metal door an aesthetic aspect similar to the one of the wood door.

The problem with this known method is that the manufacture of the panels and their filling is complicated, since it involves:
(1) the stamping of metal pieces in order to give them a decorative aspect of requested size, and the fixation onto said metal pieces of extruded aluminium pieces acting as decorative moldings;
(2) the assembly of these pieces in pair; and
(3) the filling of the space between the two pieces with an insulating material, such a filling having to be done before installation of the whole into the openings made into the metal door that has previously been manufactured.

### SUMMARY OF THE INVENTION

It has now been discovered that it is possible to solve the above mentioned problem by subjecting at least one of the metal plates used as starting materials for manufacturing the door to a stamping prior to mounting the same onto the frame of the door, so as to form zones having the requested decorative aspect at the requested place, which zones may subsequently be cut so as to install door window frames or filling panels.

Once the frame has been assembled and the insulating material has been injected, it is then possible to proceed to the requested cutting and:
either to reinstall the pieces as filling panels by means of plastic moldings;
or to set aside the cut pieces for the purpose of installing them into holes made in other doors, and to use window frames as substitutes therefore.

This new way of proceeding has the advantage of making the manufacturing and assembling steps much simpler. Indeed, the pieces that are stamped and cut into the basic structure of the door do not have to be reformed and redimensioned in order to be installed. They can be reinstalled as such with conventional plastic moldings which complete the aspect of the whole assembly.

Another advantage of this process is that one can give any kind of shape to the decorative panels, namely shapes that are not necessarily square or rectangular, without having to adjust the shape and cutting of the openings of made into door and of the decorative panels that are to be positioned into such openings. Inasmuch as the decorative panels are cut in the door, they have the same shape as the resulting openings and can be reinserted and reinstalled very easily.

The present invention is therefore directed to a process for the manufacture of a metal door incorporating at least one decorative panel that gives to the door an aesthetic aspect similar to the one of a wood door, the metal door comprising two metal plates connected to a frame which altogether form a hollow structure in which an insulating material is injected. This process comprises:
stamping at least one of said metal plates prior to mounting the same onto the frame, in order to form zones having the requested decorative aspect at a given place thereon;
assembling the two metal plates of the door, including the stamped one, onto the frame in order to form the hollow structure;
inserting the hollow structure that is so formed into a mold and injecting to this hollow structure the insulating material;
cutting the door that is so obtained to separate from the same one or more decorative panels at the places where have been formed the zones of decorative aspect, said cutting giving one or more corresponding openings into the door: and
installing by means of moldings the one or more decorative panels that have previously been cut into said one or more openings of the same door or into opening(s) of another door of the same shape and size.

The invention is also directed to the metal doors that are so manufactured.

As mentioned hereinabove, one can, if needs be, substitute a window frame to one of the cut decorative panels. Such depends exclusively of the choice of the user.

The invention and its advantages will be better understood upon reading the non-restrictive description that follows, made with reference to the accompanying drawings.

### BRIEF DESCRIPTION OF THE DRAWINGS

FIG. 1 is a perspective view of one of the metal plates used for the manufacture of a door according to the invention;

FIG. 2 is a perspective view of the metal plate shown in FIG. 1, after it has been subject to a stamping in order to form zones having a decorative aspect;

FIG. 3 is a perspective view of the door once, the two metal plates have been assembled to a rectangular frame and the hollow structure that has been so formed has been filled up with an insulating material;

FIG. 4 is exploded perspective view of the door shown in FIG. 3, illustrating the way it is cut to separate decorative panels from the same at the places where they have been formed;

FIG. 5 is exploded perspective view illustrating the way the decorative panels previously cut can be reinstalled, the said view illustrating also the moldings used to complete the assembly of the door; and

FIG. 6 is a perspective view of the metal door once it has been manufactured and assembled.

### DETAILED DESCRIPTION OF THE INVENTION

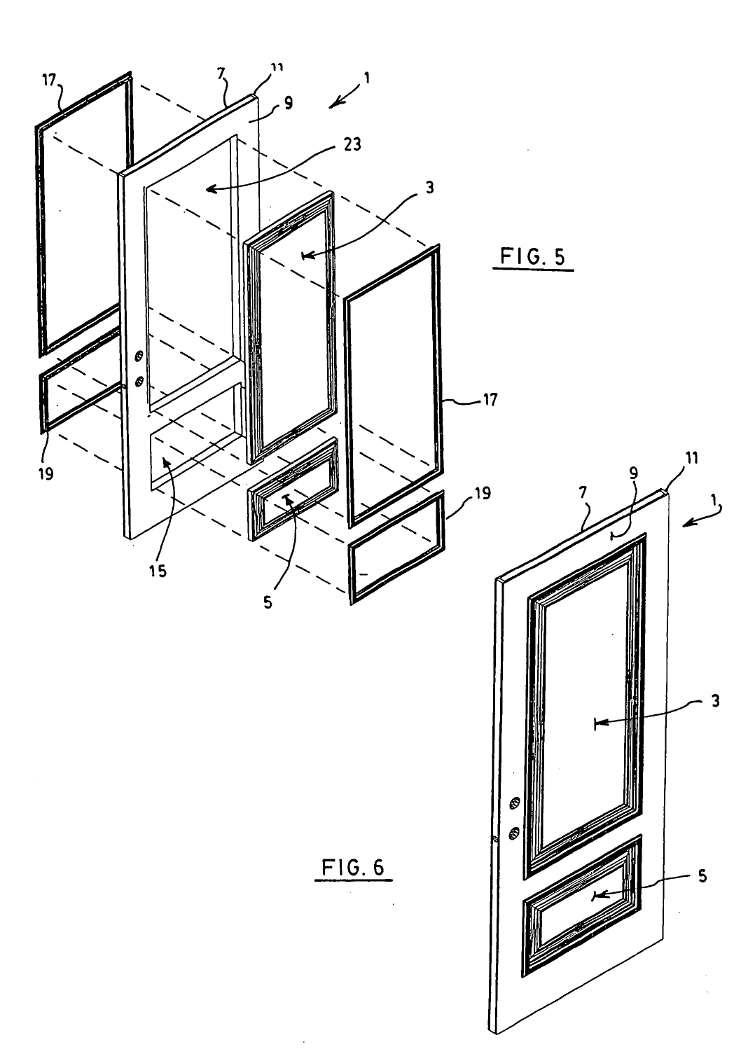

As previously mentioned, the invention is directed to a process for the manufacture of a door 1 made of metal (see FIGS. 5 and 6) which incorporates, in the illustrated embodiment, two decorative panels 3 and 5 that give to the door an aesthetic aspect similar to the one of the wood door. It is worth noting however that the door could comprise only one decorative panel and would comprise more than two decorative panels. It may also be understood that the decorative panels shown in the drawings could be replaced by window frames, as it will be explained hereinafter in greater detail.

Like in all the doors of this type, the door 1 according to the invention comprises two metal plates 7 and 9 assembled onto a frame 11 which is preferably rectangular. Such an assembly defines a hollow structure in which is injected an insulating material, such as polyurethane.

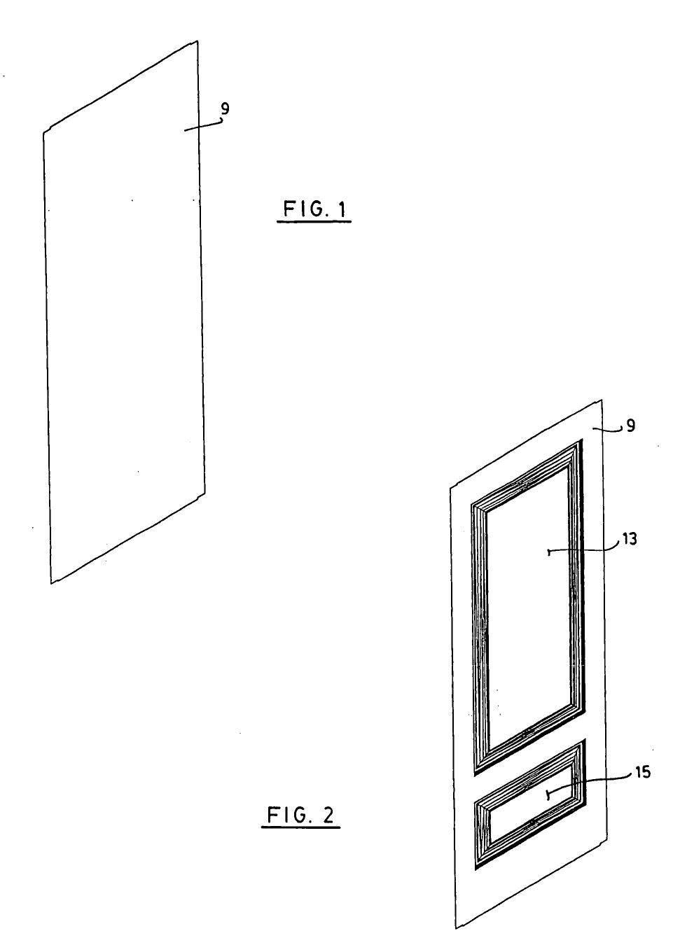

The process according to the invention distinguishes over the known processes in that before assembly of the door, at least one of the metal plates 7 and 9 and preferably both of them as shown in the drawings, are subjected to a stamping in order to form zones 13 and 15 having a decorative aspect. FIGS. 1 and 2 show the way the stamping of the metal plates 7 and 9 can be made in order to form the zones 13 and 15.

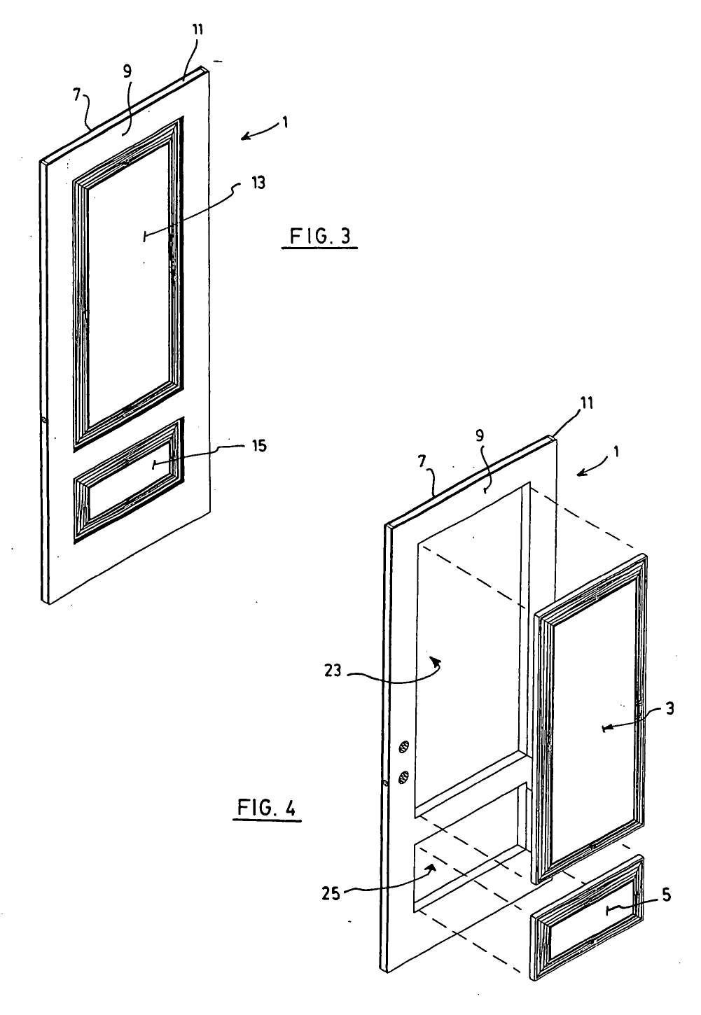

Once the stamping is completed, the two metal plates 7 and 9 of the door can be assembled onto the frame 11 in order to form the requested hollow structure. This structure is illustrated in FIG. 3.

Once the assembly is completed, the hollow structure that is so formed is inserted into a mold in order to inject therein the requested insulating material. This step is well known in this field and does not need to be described in greater detail.

The next step consists in cutting the door that is so obtained in order to separate from the same the decorative panels 3 and 5 at the places where the zones of decorative aspect 13 and 15 have been formed. In fact, the decorative panels that are so separated correspond to the zones that have been previously formed into the metal plate during the stamping carried out before assembly. Of course, this cutting creates corresponding openings 23 and 25 into the door.

The last step that is shown in FIG. 5 consists in reinstalling by means of moldings 17 and 19 into the openings 23 and 25, the decorative panels 3 and 5 that have been previously cut into the same door, or alternatively other decorative panels of the same shape and size that have been cut into another door. Alternatively also, use can be made of window frame instead of decorative panels.

In practice, the moldings 17 and 19 are preferably made of plastic material and formed in such a manner as to further reinforce the aesthetic aspect of the decorative panels and of the whole door. It may be understood however that other materials could be used, if needs be.

As previously mentioned in the preamble of the present description, the process according to the invention has the advantage of simplifying the manufacture and assembling steps. Indeed, the panels that are stamped and cut into the basic structure of the door, do not have to be reformed and redimensioned in order to be installed. They can be installed as such with conventional plastic moldings that complete the aesthetic aspect of the whole door. Alternatively, the panels may be replaced by other elements such as window frames. In such a case, provided that from one door to another, the dimension of the zones remains the same, one can reuse decorative panels from one door to complete another door or remove a decorative panel from one door to insert a window frame or another kind of panels.

Another advantage of the process according to the invention is that one can give any desired shape to the decorative panels. In fact, this shape is not necessarily square or rectangular as is shown in the accompanying drawings. This shape could be oval or still different. In all cases, the advantage is that it is not necessary to adjust the decorative panel to the shape of the openings made into the door. Indeed, since the panels are cut into the same door and another similar door, they have the same shape and can be reinstalled or installed in another door is very easily.

Of course, numerous modifications could be made to the preferred embodiment disclosed hereinabove without departing from the scope of the present invention.

1. A process for the manufacture of a metal door incorporating at least one decorative panel that gives to the door an aesthetic aspect similar to the one of a wood door, said metal door comprising two metal plates connected to a frame which altogether form a hollow structure in which an insulating material is injected, said process comprising:
stamping at least one of said metal plates prior to mounting the same onto the frame, in order to form zones having the requested decorative aspect at a given place thereon;
assembling the two metal plates of the door, including the stamped one, onto the frame in order to form the hollow structure;
inserting the hollow structure that is so formed into a mold and injecting to this hollow structure the insulating material;
cutting the door that is so obtained to separate from the same one or more decorative panels at the places where have been formed the zones of decorative aspect, said cutting giving one or more corresponding openings into the door; and
installing by means of moldings the one or more decorative panels that have previously been cut into said one or more openings of the same door or into opening(s) of another door of the same shape and size.

2. The process of claim 1, comprising the additional step of:
substituting at least one of said decorative panels for a window frame; and
installing said window frame with the same moldings within the corresponding opening cut into the door.

3. The process of claim 1, wherein:
the metal plates are made of steel;
the insulating material is a polyurethane based material; and
the moldings are made of rigid plastic material.

4. The process of claim 2, wherein:
the metal plates are made of steel:
the insulating material is a polyurethane based material; and
the moldings are made of rigid plastic material.

5. A metal door incorporating at least one decorative panel, as manufactured by the process according to claim 1.

6. A metal door incorporating at least one decorative panel, as manufactured by the process according to claim 4.
